(19) United States
(12) Patent Application Publication
(10) Pub. No.: US 2012/0170995 A1
(43) Pub. Date: Jul. 5, 2012

(54) METHOD FOR THE ADJUSTMENT OF THE WIDTH OF A FLEXIBLE SPINE MATERIAL AND DEVICE FOR THE FABRICATION OF BOOK COVERS

(76) Inventor: Reimo Albert, Donzdorf (DE)

(21) Appl. No.: 13/344,032

(22) Filed: Jan. 5, 2012

(30) Foreign Application Priority Data
Jan. 5, 2011 (DE) 10 2011 002 473.5

(51) Int. Cl. B42C 11/00

(52) U.S. Cl. 412/4; 412/19

(57) ABSTRACT

A method for the adjustment of the width of a flexible spine material in a device for the fabrication of book covers, which involves the steps of setting a desired width of the spine material on a control unit of the device for the fabrication of book covers, and of starting a size-changing program including advancing the flexible spine material and simultaneously adjusting the position of a knife adapted to cut a longitudinal edge of the flexible spine material to a position corresponding to the desired width of the spine paper material, and continuing advancement of the spine material until a spine material of the desired width is present at a spine dispenser outlet and cross cutting the spine material at the spine dispenser outlet.

### CROSS REFERENCE TO RELATED APPLICATION

This application claims the priority of German Patent Application No. 10 2011 002 473.5 filed on Jan. 5, 2011, the entire disclosure of which is hereby incorporated by reference into this application.

### FIELD OF THE INVENTION

The invention relates to a method for the adjustment of the width of a flexible spine material in a device for the fabrication of book covers. The invention also relates to a device for the fabrication of book covers using a spine processing device for feeding flexible spine material from a roll.

### BACKGROUND OF THE INVENTION

In known devices adapted for the fabrication of book covers and capable of processing flexible spine, changing the width of the back book cover to be fabricated is carried out by manually removing the spine material from the device or the machine and mechanically adjusting the knives to the newly desired width of the spine. The flexible spine material is then rethreaded into the spine processing device. On completion of a production batch for the fabrication of book covers having a specific width of the back cover and thus a specific width of the flexible spine, all book cover items are first of all removed from the machine. When use is made of flexible spine drawn from a roll, this will mean that the feed roll in the spine processing device must be uncovered, the spine must be manually withdrawn, the web of spine must be cut off from the spine bobbin and, following the adjustment of the knives to the new size of the spine, the spine must be manually rethreaded from the spine bobbin through to the spine dispenser outlet. When only a change in the back portion of the book covers to be fabricated is required, this signifies an unnecessary wastage of time, since it is still possible to operate using the same roll of flexible spine. The flexible spine material can be bogus paper material.

It is an object of the invention to provide an improved method for the adjustment of the width of a flexible spine material and to provide an improved device for the fabrication of book covers.

In the present invention, a method for the adjustment of the width of a flexible spine material in a device for the fabrication of book covers is characterized in that a desired width of the spine material is set on a control unit in the device for the fabrication of book covers, and a size-changing program is started, which size-changing program includes the following steps:
advancing the flexible spine material and simultaneously adjusting the position of at least one knife adapted to cut a longitudinal edge of the flexible spine material to a position corresponding to the desired width of the spine,
continuing the advancement of the spine material until spine material of the desired width is present at the spine dispenser outlet, and
cross cutting the spine material at the spine dispenser outlet.

This measure obviates the necessity to remove the spine material from the machine, but instead the spine material will be simply and automatically further transported until it appears with its new width at the discharge point of the spine processing device. Following commencement of the size adjustment, a strip of spine is transported in the spine processing device, and the knives for cutting the width of the spine are concomitantly moved while the web of spine is advanced. Thus a wedge-shaped piece is cut from the strip of spine during the adjustment of the knives. This wedge-shaped piece is pushed out until it reaches the spine dispenser outlet such that flexible spine having the desired width is then present at the spine dispenser outlet. The transport of the web of spine is then stopped and an automatic cross cut of the web of spine is carried out. Finally, the detached piece of flexible spine material must then be removed as garbage.

The invention provides a program controlled change of spine width without intervention of the user, by which means shorter change-over times are achieved, on the one hand, and less waste material is produced during a size change, on the other.

In a development of the invention, two knives are adjusted, each of which cuts a longitudinal edge of the flexible spine material.

The problem underlying the present invention is also solved by a device for the fabrication of book covers using a spine processing device adapted to feed flexible spine material from a roll, in which device the spine processing device has at least one adjustable knife for the purpose of cutting the flexible spine material along at least one longitudinal edge to a desired width and in which at least one control unit and an actuator for adjusting the position of the at least one knife are provided, such that, following setting to a desired width of the spine on the control unit, the execution of a size-changing program causes the at least one adjustable knife to be automatically set to a desired width of the spine simultaneously with continued transport of the flexible spine, and that the spine having the desired width is cross cut at the spine dispenser outlet.

In a development of the invention, two adjustable knives are provided for the purpose of cutting both longitudinal edges of the flexible spine material.

In a development of the invention, the knives are in the form of disk knives.

### BRIEF DESCRIPTION OF THE DRAWINGS

Other features and advantages of the invention are disclosed in the claims and in the following description of a preferred embodiment of the invention with reference to the drawings, in which:

FIG. 1 is a diagrammatical illustration of a device of the invention for the fabrication of book covers and

FIGS. 2 to 5 are diagrammatical illustrations of various stages of the method of the invention for the adjustment of the width of a flexible spine material.

### DETAILED DESCRIPTION

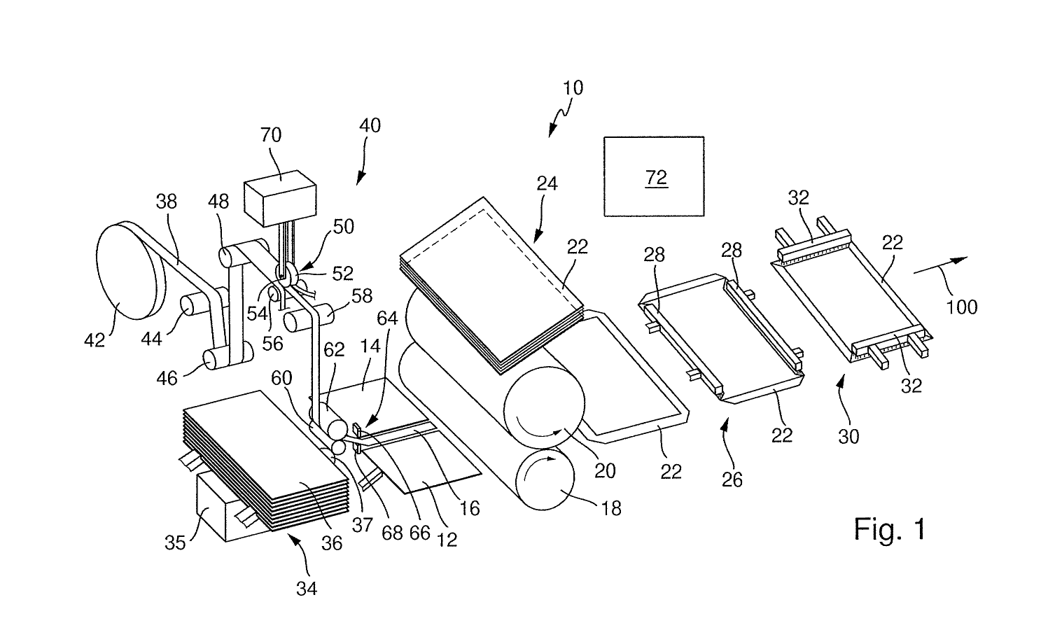

FIG. 1 is a diagrammatical illustration of a device 10 of the invention for the fabrication of book covers. The book covers usually consist of two cover boards 12, 14 and a flexible backing reinforcement or flexible spine 16 placed between the two cover boards 12, 14. The cover boards 12, 14 with the spine 16 disposed therebetween are passed between two pressure rollers 18, 20 and at the same time pressed against a book cover blank 22 fed from a cover blank magazine 24. The book cover blank is glued on one side so that, following passage through the pressure rollers 18, 20, the cover boards 12, 14 and the spine 16 are adhesively attached to the book cover blank 22. At a first turnover station 26, the flaps extending on the book cover blank 22 beyond the upstream and downstream external edges of the cover boards 12, 14, respectively, as regarded in the direction of transport 100, and the spine 16, are turned over and pressed against the same by brush strip elements 28. At a second turnover station 30, the right-hand and left-hand flaps respectively of the book cover blank 22 are then turned, by means of brush strip elements 32, over the lateral edges of the cover boards 12, 14. The thus finished book cover is then moved on in a manner not shown and stacked, for example.

The cover boards 12, 14 are delivered from a board magazine 34. In the illustration, the board magazine 34 contains boards 36 having a width equal to the sum of the widths of the cover boards 12, 14. During the process of feeding the boards 36 from the board magazine 34, by feading means 35 only diagrammatically shown, they are cut to the size of the cover boards 12, 14 by a rotary cutter device 37 only diagrammatically shown. Alternatively, the cover boards 12, 14 can be stored in twin stacks in the board magazine 34, already cut to the final dimensions.

The flexible spine 16 is fed in by means of a spine processing device 40. The flexible spine 16 is stored in the spine processing device 40 in the form of a web or strip on a roll 42, said roll being called a spine bobbin. The flexible spine is fed via rollers 44, 46, 48 to a cutting station 50 in the spine processing device 40, in which two disk knives 52, 54 are disposed above two counter-knives or a counter-roller 56, and the flexible spine material 38 coming from the roll 42 is cut to the desired width. As illustrated, the two disk knives 52, 54 cut the flexible spine material 38 along both longitudinal edges such that the flexible spine is present in the desired width at a deflection roller 58 downstream of the cutting station 50. Two further feed rolls 60, 62 then guide the flexible spine into the plane of the cover boards 12, 14. A spine dispenser outlet 64 of the spine processing device 40 has a movable revolving knife 66 that can be advanced toward a stationary bed knife 68 for the purpose of cross cutting the flexible spine material at the spine dispenser outlet 64.

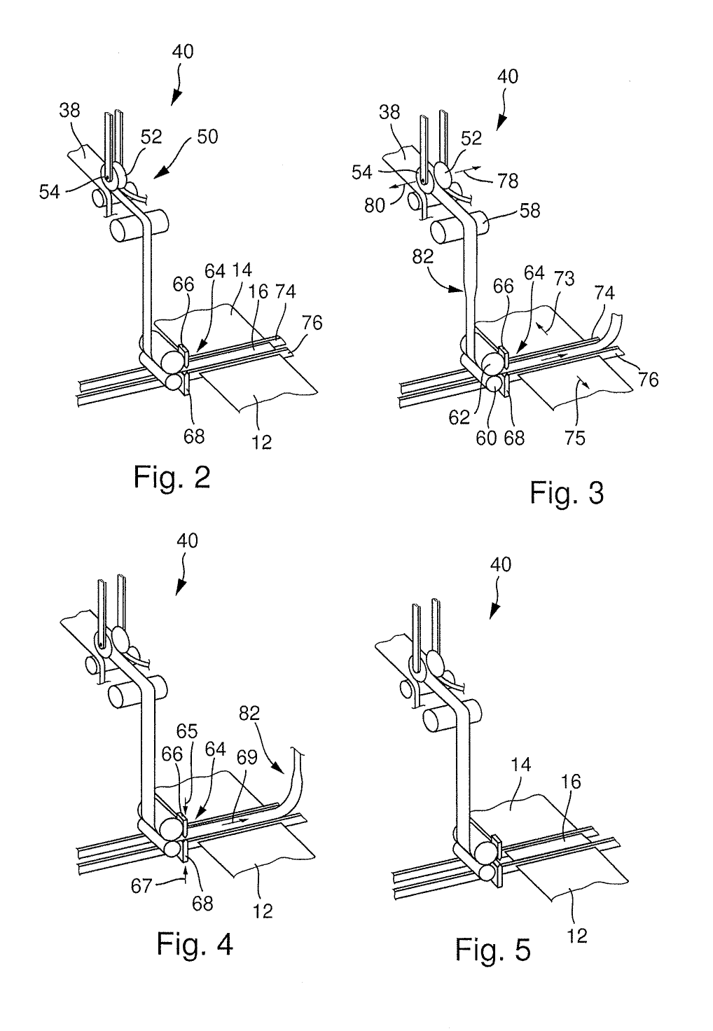

The two disk knives 52, 54 can be moved by means of a common actuator 70, illustrated diagrammatically, in the direction of their axes of rotation, in order that the width of the flexible spine can by this means be adjusted to a desired value downstream of the disk knives 52, 54. The actuator 70 is controlled by means of a control unit 72, on which the width of the flexible spine can be set to a desired value in a manner not shown and a size-changing program can be started. If, on completion of a production batch involving the fabrication of book covers, a different width of the flexible spine 16 is required, the new width of the spine is set on the control unit 72, and a size-changing program is started. Controlled by the control unit 72, drawing of the flexible spine material 38 from the roll 42 is continued. Simultaneously, the control unit 72 controls the actuator 70 in such a manner that it gradually moves the two disk knives 52, 54 to a position that causes the flexible spine to have the desired width downstream of the disk knives 52, 54. As explained below with reference to FIGS. 2 to 5, there is thus formed a wedge-shaped piece in the flexible spine during the adjustment of the knives combined with the withdrawal of the flexible spine. This region cut in the form of a wedge is then transported to the spine dispenser outlet 64 such that it is situated downstream of the knives 66, 68. The flexible spine is then cross cut by means of the knives 66, 68, and flexible spine having the desired width is then located such that its end is in line with the spine dispenser outlet 64.

The illustration in FIG. 2 depicts the spine processing device 40 partly diagrammatically, in which the actuator 70 illustrated in FIG. 1 is omitted for the sake of clarity.

The flexible spine material 38 is fed to the cutting station 50, where, as already explained, it is cut along the two longitudinal edges to the desired width by means of the disk knives 52, 54. Visible at the spine dispenser outlet 64 are the two knives 66, 68 which cross cut the flexible spine 16 to the desired length during production. The flexible spine 16 and the cover boards 12, 14 are spaced by the desired distance by means of two stop bars 74, 76.

Once a newly desired width of the flexible spine 16 has been set on the control unit 72 (see FIG. 1) and the size-changing program has been started, the two disk knives 52, 54 are moved outwardly as shown in FIG. 3 in the direction of the arrows 78 and 80 respectively in order to provide a desired greater width of the spine while at the same time the transport of the spine 16 is continued. The delivery rate of the spine 16 is adapted to the speed of displacement of the disk knives 52, 54 such that a gradually increasing or decreasing width of the spine 16 is attained. In the state shown in FIG. 3, the adjustment of the disk knives 52, 54 has been completed and the resulting wedge-shaped piece 82 cut from the flexible spine 38 during said adjustment and advancement of said piece is visible in the illustration in FIG. 3 between the deflection roller 58 and the two feed rolls 60, 62 in the region of the spine dispenser outlet 64.

Flexible spine material having the desired width is then available upstream of the wedge-shaped piece 82.

As indicated by further arrows 73, 75 in FIG. 3, the two stop bars 74. 76 are also moved outwardly as the size-changing program proceeds and are thus set to the new, greater width of the flexible spine 16.

Once the wedge-shaped piece 82 has passed the spine dispenser outlet 64, as is illustrated in FIG. 4, the transport of the spine is stopped (see arrow 69) and the revolving knife 66 at the spine dispenser outlet 64 is moved toward the bed knife 68 in order to cross cut the flexible spine material, as indicated by arrows 65, 67. The piece of flexible spine material situated downstream of the spine dispenser outlet 64 is then disposed of as garbage.

In the state shown in FIG. 5, the size-changing program has been completed and book covers having a flexible spine 16 of the desired, new width can be fabricated.

Size changing is carried out automatically under the control of the size-changing program, and only the removal of the detached waste piece of flexible spine material must be carried out manually, as illustrated in FIG. 4.

If it is necessary, starting from the state shown in FIG. 5, to reset to a smaller width of the flexible spine 16, this can likewise take place under the control of the size-changing program and the control unit 72, which procedure can then be depicted by reference to FIG. 5, FIG. 4, FIG. 3, and FIG. 2, in that order.

The method of the invention and the device of the invention thus provide a program controlled change of spine width without the intervention of a user with the exception of the removal of the detached piece of garbage. This leads to shorter change-over times and the occurrence of less waste material when executing a size change.

1. A method for the adjustment of the width of a flexible spine material in a device for the fabrication of book covers, including setting a desired width of said spine material on a control unit of said device for the fabrication of book covers and starting a size-changing program involving the following steps:
advancing the flexible spine material and simultaneously adjusting the position of at least one cutting knife, adapted to cut a longitudinal edge of said flexible spine material, to a position corresponding to the desired width of said spine,
further advancing the spine material until spine material of the desired width is present at a spine dispenser outlet, and
cross cutting said spine material at said spine dispenser outlet.

2. The method as defined in claim 1, including adjusting the position of two knives each adapted to cut a longitudinal edge of said flexible spine material.

3. A device for the fabrication of book covers by means of a spine processing device adapted to feed a flexible spine material from a roll, wherein the spine processing device has at least one adjustable knife to make it possible to cut said flexible spine material along at least one longitudinal edge to achieve a desired width and that at least one control unit and one actuator re provided for adjusting the position of the at least one knife, in order that, after having set a desired width of the spine material on the control unit, said material can be automatically cut to a desired spine width by starting a size-changing program which moves the adjustable knives while the advancement of said flexible spine material is continued and cross cutting said spine material having the desired width at a spine dispenser outlet.

4. The device as defined in claim 3, wherein two adjustable knives are provided for the purpose of cutting said flexible spine material along both longitudinal edges.

5. The device as defined in claim 3, wherein the knives are in the form of disk knives.

6. The device as defined in claim 4, wherein the knives are in the form of disk knives.
